(19) United States
(12) Patent Application Publication
(10) Pub. No.: US 2026/0280806 A1
(43) Pub. Date: Sep. 17, 2026

(54) WIRELESS COMMUNICATION METHOD OF AI/ML, UE, AND NETWORK DEVICE

(71) Applicant: SHENZHEN TCL NEW TECHNOLOGY CO., LTD., Shenzhen, Guangdong (CN)

(72) Inventor: Xiaoyong TANG, Shenzhen, Guangdong (CN)

(73) Assignee: SHENZHEN TCL NEW TECHNOLOGY CO., LTD., Shenzhen, Guangdong (CN)

(21) Appl. No.: 19/471,366

(22) PCT Filed: Apr. 7, 2023
(86) PCT No.: PCT/CN2023/087152

§ 371 Date: Sep. 30, 2025

(51) Int. Cl. H04L 5/00

(52) U.S. Cl. CPC H04L 5/0051

(57) ABSTRACT

A wireless communication method of artificial intelligence (AI)/machine learning (ML) includes configurating, to a user equipment (UE), an AI/ML model specific reference signal configuration. The AI/ML model specific reference signal configuration includes an indication to indicate a reference signal usage of an AI/ML model specific reference signal, and the reference signal usage includes at least one of the following: AI/ML functionality, AI/ML model, AI/ML model procedure, and/or AI/ML scenario.

### BACKGROUND OF DISCLOSURE

### 1. Field of the Disclosure

The present disclosure relates to the field of wireless communication systems, and more particularly, to wireless communication methods of artificial intelligence (AI)/machine learning (ML), a user equipment (UE), and a network device, for example, the present disclosure is related to the AI/ML for new radio (NR) air interface which had been discussed at Release 18 (Rel.18), and the main idea mainly focus on RAN1 topics, including uplink/downlink measurement configuration such as reference signal configuration (channel state information-reference signal (CSI-RS), sounding reference signal (SRS), demodulation reference signal (DMRS), etc.), and AI/ML based measurement and reporting, supporting the AI/ML models working normally at a network with extremally less signaling interaction between a gNB and a UE.

### 2. Description of the Related Art

Until 3GPP RAN1 #111 meeting, many wireless AI/ML related topics had been discussed, including the use cases (CSI compressing/prediction/measurement, positioning, beam management, RRM, etc.), system-level and link-level simulations, life cycle management, some key conclusions and agreements had been achieved, especially the AI/ML lifecycle management framework, which is the fundamental for the wireless AI/ML standardization. Even a general framework had been proposed, but how to define a universal procedure satisfying different use cases is a big challenge right now. How to support AI/ML model specific reference signal configuration and data collection (CSI, positioning, beam management, inference, training, and monitoring etc.) needs to be studied in the future, and there is no prior art to deal with it.

### SUMMARY

An object of the present disclosure is to propose wireless communication methods of artificial intelligence (AI)/machine learning (ML), a user equipment (UE), and a network device, which can solve the issues in the prior art, reduce signaling overhead, provide scalability to various models' requirement for one AI/ML model type, and unify one-side model or two-side model's procedure with a single AI/ML model specific process.

In a first aspect of the present disclosure, a wireless communication method of artificial intelligence (AI)/machine learning (ML) includes configurating, to a user equipment (UE), an AI/ML model specific reference signal configuration, wherein the AI/ML model specific reference signal configuration comprises an indication to indicate the usage of a reference signal, where the usage comprises at least one of AI/ML functionality, AI/ML model, AI/ML model procedure, and/or AI/ML scenario.

In a second aspect of the present disclosure, a wireless communication method of artificial intelligence (AI)/machine learning (ML) includes determining, by a user equipment (UE), an AI/ML model specific reference signal configuration, wherein the AI/ML model specific reference signal configuration comprises an indication to indicate a reference signal usage of an AI/ML model specific reference signal, and the reference signal usage comprises at least one of the following: AI/ML functionality, AI/ML model, AI/ML model procedure, and/or AI/ML scenario.

In a third aspect of the present disclosure, a wireless communication device includes a configurer configured to configure, to a user equipment (UE), an AI/ML model specific reference signal configuration, wherein the AI/ML model specific reference signal configuration comprises an indication to indicate a reference signal usage of an AI/ML model specific reference signal, and the reference signal usage comprises at least one of the following: AI/ML functionality, AI/ML model, AI/ML model procedure, and/or AI/ML scenario.

In a fourth aspect of the present disclosure, a wireless communication device includes a determiner configured to determine an AI/ML model specific reference signal configuration, wherein the AI/ML model specific reference signal configuration comprises an indication to indicate a reference signal usage of an AI/ML model specific reference signal, and the reference signal usage comprises at least one of the following: AI/ML functionality, AI/ML model, AI/ML model procedure, and/or AI/ML scenario.

In some embodiments, the indication to indicate the reference signal usage comprises at least one of the following: an identifier of the AI/ML model; an identifier of the AI/ML type; an identifier of the AI/ML functionality; an identifier of the AI/ML scenario; an identifier of the AI/ML model procedure; an identifier of the reference signal; a string-based indication; an ID-based indication; a bitmap-based indication; a hierarchical methodology-based indication; and/or an order-based indication. In some embodiments, through the order-based indication, the AI/ML model specific reference signal usage are indicated with different configured orders. In some embodiments, the AI/ML model specific reference signal comprises at least one of the channel state information reference signal (CSI-RS), demodulation reference signal (DMRS), sounding reference signal (SRS), phase tracking reference signal (PTRS), and/or positioning reference signal (PRS). In some embodiments, the method further comprises receiving, from the UE, an AI/ML model specific reporting information configuration, wherein the AI/ML model specific reporting information configuration comprises an indication to indicate an AI/ML model information. In some embodiments, the indication to indicate the AI/ML model information comprises at least one of the following: an identifier of the AI/ML model; an identifier of the AI/ML type; an identifier of the AI/ML functionality; an identifier of the AI/ML model procedure; an identifier of the AI/ML scenario; and/or an identifier of the reference signal.

In some embodiments, the AI/ML model specific reference signal configuration and/or the AI/ML model specific reporting information configuration are active/de-active by a triggering information. In some embodiments, the triggering information comprises at least one of the following: an identifier of the AI/ML model; an identifier of the AI/ML type; an identifier of the AI/ML functionality; an identifier of the AI/ML scenario; an identifier of the AI/ML model procedure; an identifier of the reference signal; an identifier of a reporting quantity; active timing; and/or de-active timing. In some embodiments, the method further comprises: configurating, to the UE, a reporting, wherein the reporting is configured to indicate a measurement information between a network device and the UE based on the AI/ML model specific reference signal.

In some embodiments, the method further comprises configurating, to the UE, an AI/ML model specific channel state information. In some embodiments, the AI/ML model specific channel state information comprises: an identifier of the AI/ML model; an identifier of the AI/ML type; an identifier of the AI/ML functionality; an identifier of the AI/ML model procedure; an identifier of the AI/ML scenario; and/or an identifier of the reference signal.

In some embodiments, the indication to indicate the reference signal usage comprises: an identifier of the AI/ML model; an identifier of the AI/ML type; an identifier of the AI/ML functionality; an identifier of the AI/ML model procedure; an identifier of the AI/ML scenario; an identifier of the reference signal; a string-based indication; an ID-based indication; a bitmap-based indication; a hierarchical methodology-based indication; and/or an order-based indication. In some embodiments, through the order-based indication, the AI/ML model specific reference signal usage are indicated with different configured orders. In some embodiments, the AI/ML model specific reference signal comprises at least the following one, channel state information-reference signal (CSI-RS), demodulation reference signal (DMRS), sounding reference signal (SRS), phase tracking reference signal (PTRS), and/or a positioning reference signal (PRS). In some embodiments, the method further comprises: transmitting, from or to a network device, an AI/ML model specific reporting information configuration, wherein the AI/ML model specific reporting information configuration comprises an indication to indicate an AI/ML model information. In some embodiments, the indication to indicate the AI/ML model information comprises: an identifier of the AI/ML model; an identifier of the AI/ML type; an identifier of the AI/ML functionality; an identifier of the AI/ML model procedure; an identifier of the AI/ML scenario; and/or an identifier of the reference signal. In some embodiments, the AI/ML model specific reference signal configuration and/or the AI/ML model specific reporting information configuration are active/de-active by a triggering information.

In some embodiments, the triggering information comprises: an identifier of the AI/ML model; an identifier of the AI/ML type; an identifier of the AI/ML functionality; an identifier of the AI/ML scenario; an identifier of the AI/ML model procedure; an identifier of the reference signal; an identifier of a reporting quantity; active timing; and/or de-active timing. In some embodiments, the method further comprises: determining, by the UE, a reporting, wherein the reporting is configured to indicate a measurement information between a network device and the UE based on the AI/ML model specific reference signal. In some embodiments, the method further comprises: determining, by the UE, an AI/ML model specific channel state information. In some embodiments, the AI/ML model specific channel state information comprises: an identifier of the AI/ML model; an identifier of the AI/ML type; an identifier of the AI/ML functionality; an identifier of the AI/ML model procedure; an identifier of the AI/ML scenario; and/or an identifier of the reference signal.

In a fifth aspect of the present disclosure, a network device comprises a memory, a transceiver, and a processor coupled to the memory and the transceiver. The processor is configured to execute the above method.

In a sixth aspect of the present disclosure, a UE comprises a memory, a transceiver, and a processor coupled to the memory and the transceiver. The processor is configured to execute the above method.

In a seventh aspect of the present disclosure, a non-transitory machine-readable storage medium has stored thereon instructions that, when executed by a computer, cause the computer to perform the above method.

In an eighth aspect of the present disclosure, a chip includes a processor, configured to call and run a computer program stored in a memory, to cause a device in which the chip is installed to execute the above method.

In a ninth aspect of the present disclosure, a computer readable storage medium, in which a computer program is stored, causes a computer to execute the above method.

In a tenth aspect of the present disclosure, a computer program product includes a computer program, and the computer program causes a computer to execute the above method.

In an eleventh aspect of the present disclosure, a computer program causes a computer to execute the above method.

### BRIEF DESCRIPTION OF DRAWINGS

In order to illustrate the embodiments of the present disclosure or related art more clearly, the following figures will be described in the embodiments are briefly introduced. It is obvious that the drawings are merely some embodiments of the present disclosure, a person having ordinary skill in this field can obtain other figures according to these figures without paying the premise.

FIG. 1 is a schematic diagram illustrating an example of an AI/ML general framework for wireless communication.

FIG. 2 is a schematic diagram illustrating an example of a basic auto-encoder model for enhanced CSI feedback according to an embodiment of the present disclosure.

FIG. 3 is a block diagram of nodes of communication in a communication network system according to an embodiment of the present disclosure.

FIG. 4A is a flowchart illustrating a wireless communication method of artificial intelligence (AI)/machine learning (ML) according to an embodiment of the present disclosure.

FIG. 4B is a flowchart illustrating a wireless communication method of artificial intelligence (AI)/machine learning (ML) according to an embodiment of the present disclosure.

FIG. 5A is a flowchart illustrating a wireless communication method of artificial intelligence (AI)/machine learning (ML) by a network device according to an embodiment of the present disclosure.

FIG. 5B is a flowchart illustrating a wireless communication method of artificial intelligence (AI)/machine learning (ML) by a network device according to an embodiment of the present disclosure.

FIG. 6A is a flowchart illustrating a wireless communication method of artificial intelligence (AI)/machine learning (ML) by a UE according to an embodiment of the present disclosure.

FIG. 7A is a flowchart illustrating a wireless communication method of artificial intelligence (AI)/machine learning (ML) by a UE according to an embodiment of the present disclosure.

FIG. 8 is a flowchart illustrating downlink AI/ML model specific resource configuration and feedback according to an embodiment of the present disclosure.

FIG. 9 is a flowchart illustrating uplink AI/ML model specific resource configuration and feedback according to an embodiment of the present disclosure.

FIG. 10 is a schematic diagram illustrating AI/ML model specific active/de-active timing according to an embodiment of the present disclosure.

FIG. 11 is a schematic diagram illustrating AI/ML model specific uplink feedback according to an embodiment of the present disclosure.

FIG. 12A is a block diagram of a communication device such as UE according to an embodiment of the present disclosure.

FIG. 12B is a block diagram of a communication device such as a network device according to an embodiment of the present disclosure.

FIG. 13A is a block diagram of a communication device such as UE according to an embodiment of the present disclosure.

FIG. 13B is a block diagram of a communication device such as a network device according to an embodiment of the present disclosure.

FIG. 14 is a block diagram of a system for wireless communication according to an embodiment of the present disclosure.

### DETAILED DESCRIPTION OF EMBODIMENTS

Embodiments of the present disclosure are described in detail with the technical matters, structural features, achieved objects, and effects with reference to the accompanying drawings as follows. Specifically, the terminologies in the embodiments of the present disclosure are merely for describing the purpose of the certain embodiment, but not to limit the disclosure.

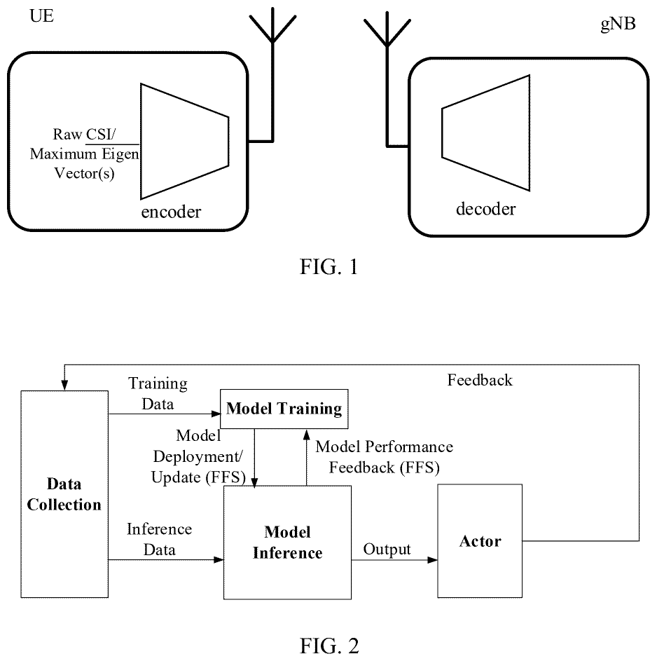

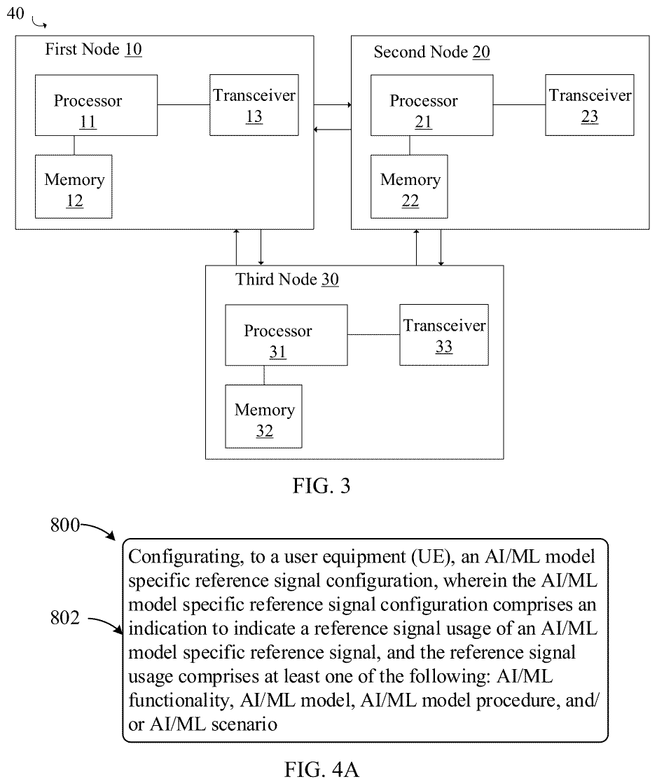

As illustrated by FIG. 1, data collection, model inference, and feedback perform the key role at the system, those processes are AI/ML model specific, and associated information are various between different models, as shown in table 1. For example, channel measurements, e.g., a power delay profile (PDP), a channel impulse response (CIR), a channel frequency response (CFR) or post-processed CIR, and ground-truth UE coordinates are required for UE-based AI/ML positioning methodology. But for beam management, the following information is required, including new reference signal received power (RSRP) and/or synchronization signal block (SSB) resource indicator (SSBRI)/CSI reference signal (CSI-RS) resource indicator (CRI) (SSBRI/CRI) report behavior. E.g., a larger number of RSRPs is to be reported to generate the labels and AI/ML inputs, or larger number of beam IDs is to be reported as the AI/ML outputs, as opposed to the legacy mode where only the best RSRP(s) are reported. In addition, when Set B is a subset of Set A, the mapping relationship between Set B and Set A may need to be aligned, e.g., which subset within Set A is configured as Set B. Also, for the CSI prediction, the requirement is quite different from positioning and beam management, including ground-truth CSI of realistic DL/UL channels, raw channel matrix or precoding matrix etc. Meanwhile, in order to fetch the assistant information from measurement or feedback, dedicated reference signal is needed. For example, enhanced RS design to perform AI/ML specific RSRP measurement and the enhancement of the RS to conduct more accurate measurements of data samples, which would be required by A/ML-based beam management. For CSI prediction, enhanced CSI-RS may be considered specifically for the data collection procedure to generate the dataset with more accurate ground-truth CSI as samples. For example, by setting a higher power to the CSI-RS or allocating more RE in time/frequency domain to the CSI-RS for data collection, so that U can achieve more accurate DL measured channel as the ground-truth CSI labels. Also, the same to positioning, dedicated RS would be needed for accuracy improvement to performance AI/ML model inference or monitoring.

TABLE 1
AI-model specific reference signal and data requirements

| AI/ML model | Reference signal | |
|---|---|---|
| functionalities | enhancement | Data requirement |
| Positioning | Positioning specific | Positioning specific data, for example, the |
| | reference signal, | channel measurements, e.g., the power delay |
| | higher density, | profile (PDP), the channel impulse response |
| | wider beam, etc. | (CIR), the channel frequency response (CFR) or |
| | | post-processed CIR and ground-truth UE |
| | | coordinates. |
| Beam | BM-specific | BM-specific data, for example, new RSRP and/or |
| management | reference signal, | SSBRI/CRI report behavior. e.g., a larger number |
| | higher power, | of RSRPs is to be reported to generate the labels |
| | higher density | and AI/ML inputs, or larger number of beam IDs |
| | different spatial | is to be reported as the AI/ML outputs, etc. |
| | filter, etc. | |
| CSI feedback | CSI-enhancement | CSI-enhancement specific data, for example, |
| enhancement | specific reference | ground-truth CSI of realistic DL/UL channels, |
| | signal, higher | raw channel matrix or precoding matrix, etc. |
| | density, and | |
| | measurement gap, | |
| | etc. | |

In the table 1, for example, AI/ML model functionalities include positioning, beam, and CSI feedback enhancement. In positioning, specific reference signal requirement includes positioning specific reference signal, higher density, wider beam, etc., and data requirement includes positioning specific data, for example, the channel measurements, e.g., the power delay profile (PDP), the channel impulse response (CIR), the channel frequency response (CFR) or post-processed CIR and ground-truth UE coordinates.

In beam management, specific reference signal requirement includes BM-specific reference signal, higher power, higher density different spatial filter, etc., and data requirement includes BM-specific data, for example, new RSRP and/or SSBRI/CRI report behavior. e.g., a larger number of RSRPs is to be reported to generate the labels and AI/ML inputs, or larger number of beam IDs is to be reported as the AI/ML outputs, etc.

In CSI feedback enhancement, specific reference signal requirement includes CSI-enhancement specific reference signal, higher density, and measurement gap, etc., and data requirement includes CSI-enhancement specific data, for example, ground-truth CSI of realistic DL/UL channels, raw channel matrix or precoding matrix, etc.

Observed from table 1, the specific required data (for feedback, training, inference input, etc.) is highly related with AI/ML functionalities and/or reference signal, unifying those configurations and data collection procedure is quite important to support functionalities AI/ML models with effective signaling method. Also, we can see until RAN1 #111 meeting, for the general framework, great efforts have been processed for simplified LCM procedure, and model ID solutions are proposed here. In the agreement, study LCM procedure on the basis that an AI/ML model has a model ID with associated information and/or model functionality at least for some AI/ML operations. Further, in UE-part/UE-side models, study the following mechanisms for LCM procedures: For functionality-based LCM procedure: indication of activation/deactivation/switching/fallback based on individual AI/ML functionality. For model-ID-based LCM procedure, indication of model selection/activation/deactivation/switching/fallback based on individual model IDs.

### Technical Problems

Based on disclosure of the present application, at least following issues has been identified, the following issues had been identified if we want to combine the model ID with AI-model specific reference signal and data collection. The technical questions mentioned here are examples only. In addition to solving these technical problems, some embodiments of the present invention can also solve other technical problems The invention is not limited to this.

Issue 1: How to Pair AI-Model Specific Information with Reference Signal

The CSI framework as defined in NR, which includes CSI-RS resource setting and reporting setting, and configure to UE with CSI-ReportConfig via RRC signaling, the CSI-ReportConfig data structure as shown in the following, three CSI-RS resource types associated with the reportQuantity are defined for CSI measurement, including channel measurement with the first CSI-RS resource configuration, and interference measurement with the second CSI-IM resource configuration, finally another kind of interference is performed by the NZP-CSI-RS resource configuration. As discussed in the above, the AI/ML-model required information would be quite different from legacy CSI framework, also the legacy CSI-RS configuration methodology has not defined the AI/ML or other usage scenario, so how to pair the AI/ML model specific information with reference signal configuration procedure needs to be clarified.

Information element (IE)

```
  -- ASN1START
  -- TAG-CSI-REPORTCONFIG-START
```

| CSI-ReportConfig ::= | SEQUENCE { | |
|---|---|---|
| reportConfigId | CSI-ReportConfigId, | |
| carrier | ServCellIndex | OPTIONAL, -- Need S |
| resourcesForChannelMeasurement | CSI-ResourceConfigId, | |
| csi-IM-ResourcesForInterference | CSI-ResourceConfigId | OPTIONAL, -- |

Need R

| | | |
|---|---|---|
| nzp-CSI-RS-ResourcesForInterference | CSI-ResourceConfigId | OPTIONAL, |

-- Need R

| | |
|---|---|
| reportConfigType | CHOICE { |
| periodic | SEQUENCE { |

...... },

| | |
|---|---|
| semiPersistentOnPUCCH | SEQUENCE { |

...... },

| | |
|---|---|
| semiPersistentOnPUSCH | SEQUENCE { |

...... },

| | |
|---|---|
| aperiodic | SEQUENCE { |

```
        ...... }
    },
```

| | |
|---|---|
| reportQuantity | CHOICE { |
| none | NULL, |
| cri-RI-PMI-CQI | NULL, |
| cri-RI-i1 | NULL, |
| cri-RI-i1-CQI | SEQUENCE { |

...... },

| | |
|---|---|
| cri-RI-CQI | NULL, |
| cri-RSRP | NULL, |
| ssb-Index-RSRP | NULL, |
| cri-RI-LI-PMI-CQI | NULL |

},

| | |
|---|---|
| reportFreqConfiguration | SEQUENCE { |

```
        ......
  }
  ......
  }
  -- TAG-CSI-REPORTCONFIG-STOP
-- ASN1STOP
```

Further, for the SRS resource configuration, the SRS resource set/SRS resource/TPC command/SRS resource has been defined for uplink channel measurement or positioning. Still, no reporting information is associated with the SRS resource configuration compared to the CSI framework. From the above analysis, some mandatory data or channel information is required for AI/NIL model when it's located on UE-side, so real-time sharing of the network information with UE has a proper procedure to guarantee this.

IE

| | |
|---|---|
| SRS-Config ::= | SEQUENCE { |
| srs-ResourceSetToReleaseList | SEQUENCE (SIZE(1..maxNrofSRS- |
| ResourceSets)) OF SRS-ResourceSetId | OPTIONAL, -- Need N |
| srs-ResourceSetToAddModList | SEQUENCE (SIZE(1..maxNrofSRS- |
| ResourceSets)) OF SRS-ResourceSet | OPTIONAL, -- Need N |
| srs-ResourceToReleaseList | SEQUENCE (SIZE(1..maxNrofSRS-Resources)) |
| OF SRS-ResourceId | OPTIONAL, -- Need N |
| srs-ResourceToAddModList | SEQUENCE (SIZE(1..maxNrofSRS-Resources)) |
| OF SRS-Resource | OPTIONAL, -- Need N |
| tpc-Accumulation | ENUMERATED {disabled} |

```
OPTIONAL, -- Need S
    ...,
    [[
```

| | |
|---|---|
| srs-RequestDCI-1-2-r16 | INTEGER (1..2) |

OPTIONAL, -- Need S

| | |
|---|---|
| srs-RequestDCI-0-2-r16 | INTEGER (1..2) |

OPTIONAL, -- Need S

| | |
|---|---|
| srs-ResourceSetToAddModListDCI-0-2-r16 | SEQUENCE (SIZE(1..maxNrofSRS- |
| ResourceSets)) OF SRS-ResourceSet | OPTIONAL, -- Need N |
| srs-ResourceSetToReleaseListDCI-0-2-r16 | SEQUENCE (SIZE(1..maxNrofSRS- |
| ResourceSets)) OF SRS-ResourceSetId | OPTIONAL, -- Need N |
| srs-PosResourceSetToReleaseList-r16 | SEQUENCE (SIZE(1..maxNrofSRS- |

PosResourceSets-r16)) OF SRS-PosResourceSetId-r16

OPTIONAL, --

Need N

| | |
|---|---|
| srs-PosResourceSetToAddModList-r16 | SEQUENCE (SIZE(1..maxNrofSRS- |
| PosResourceSets-r16)) OF SRS-PosResourceSet-r16 | OPTIONAL,-- Need N |
| srs-PosResourceToReleaseList-r16 | SEQUENCE (SIZE(1..maxNrofSRS- |
| PosResources-r16)) OF SRS-PosResourceId-r16 | OPTIONAL,-- Need N |
| srs-PosResourceToAddModList-r16 | SEQUENCE (SIZE(1..maxNrofSRS- |
| PosResources-r16)) OF SRS-PosResource-r16 | OPTIONAL -- Need N |

]]
}

Issue 2: How to Pair the AI-Model Specific Information with the CSI Reporting

Under the legacy CSI-ReportConfig definition, the CSI reporting is managed by the following IEs, including reportQuantity, reportQuantity-r16, reportQuantity-r17, csi-ReportMode-r17, sharedCMR, reportFreConfiguration, timeRestrictionForChannel/Interference Measurements, etc. Here three report quantity types have been used for different purposes and highly related to the usage, and the reportQuantity is used for traditional CSI feedback back, reportQuantity-r16 is used for more accurate beam management by involved L1-SINR information, reportQuantity-r17 CMR has been included to decrease the feedback overhead when multiple-panel used in the network.

IE

```
  -- ASN1START
  -- TAG-CSI-REPORTCONFIG-START
```

| | |
|---|---|
| CSI-ReportConfig ::= | SEQUENCE { |

......

| | |
|---|---|
| reportQuantity | CHOICE { |
| none | NULL, |
| cri-RI-PMI-CQI | NULL, |
| cri-RI-i1 | NULL, |
| cri-RI-i1-CQI | SEQUENCE {...... }, |
| cri-RI-CQI | NULL, |
| cri-RSRP | NULL, |
| ssb-Index-RSRP | NULL, |
| cri-RI-LI-PMI-CQI | NULL |

},

| | |
|---|---|
| ...... | OPTIONAL, -- |

Need R

| | |
|---|---|
| reportQuantity-r16 | CHOICE { |
| cri-SINR-r16 | NULL, |
| ssb-Index-SINR-r16 | NULL |

| | |
|---|---|
| } | OPTIONAL, -- |

Need R
......

| | |
|---|---|
| reportQuantity-r17 | CHOICE { |
| cri-RSRP-Index-r17 | NULL, |
| ssb-Index-RSRP-Index-r17 | NULL, |
| cri-SINR-Index-r17 | NULL, |
| ssb-Index-SINR-Index-r17 | NULL |

| | |
|---|---|
| } | OPTIONAL -- |

```
Need R
    ......
  }
  -- TAG-CSI-REPORTCONFIG-STOP
-- ASN1STOP
```

Right now, several AI-models have been discussed along with the standardization progress, including one-side AI/ML model (which would be located at UE side or gNB side), two side AI/ML model (both gNB and UE had partial functionalities to finish one specific AI task). No matter whether those AI/ML models are gNB-only located or two sides, additional feedback information is required to make the AI/ML model work normally and safely, as the legacy CSI feedback framework, AI/ML model specific CSI feedback procedure is also needed, therefore, how to define the AI-model specific CSI feedback methodology which can compatible with different AI/ML models need to be further discussed, including but not only for positioning, beam management, CSI compressing, etc.

In some embodiments of this disclosure, AI/ML model-specific based measurement framework which related to the reference signal configuration, CSI measurement, and CSI reporting are proposed. This has not been discussed by RAN1 meeting, but straightforward according to the current/future Tdocs discussion. With the idea, the wireless air interface can benefit from less signaling overhead, scalability to different models' requirement for one AI/ML model type, and further unifying one-side model or two-side model's procedure with a single AI/ML model specific process. These are some summaries of the present disclosure, and some embodiments below will be described in detail as follows.

FIG. 1 is a schematic diagram illustrating an example of a basic auto-encoder model for enhanced CSI feedback according to an embodiment of the present disclosure. FIG. 1 illustrates that, in some embodiments, a basic model of auto-encoder is shown as follows. The encoder compressed the raw CSI-RS values (in short, raw CSI)/maximum Eigen vector and reports its output to the gNB. The gNB will decompress it. A new CSI report is the CSI report that contains the enhanced CSI feedback by an AI/ML model. At the UE, the input is compressed and output to the channel. The input of the encoder can be either (maximum) Eigen vectors or channel matrix. The compressed output is the input to the decoder and reconstructed at the gNB side.

FIG. 2 illustrates that, in some embodiments, at least one first node 10 such as at least one user equipment (UE), and a second node 20 such as a network device 20, and at least one third node 30 such as other communication device for communication in a communication network system 40 according to an embodiment of the present disclosure are provided. The communication network system 40 includes at least one first node 10 such as at least one user equipment (UE), and a second node 20 such as the network device 20, and at least one third node 30 such as other communication device. The at least one first node 10 may include a memory 12, a transceiver 13, and a processor 11 coupled to the memory 12 and the transceiver 13. The at least second first node 20 may include a memory 22, a transceiver 23, and a processor 21 coupled to the memory 22 and the transceiver 23. The at least one third node 30 may include a memory 32, a transceiver 33, and a processor 31 coupled to the memory 32 and the transceiver 33. The processor 11, 21, or 31 may be configured to implement proposed functions, procedures and/or methods described in this description. Layers of radio interface protocol may be implemented in the processor 11, 21, or 31. The memory 12, 22, or 32 is operatively coupled with the processor 11, 21, or 31 and stores a variety of information to operate the processor 11, 21, or 31. The transceiver 13, 23, or 33 is operatively coupled with the processor 11, 21, or 31, and the transceiver 13, 23, or 33 transmits and/or receives a radio signal.

The processor 11, 21, or 31 may include application-specific integrated circuit (ASIC), other chipset, logic circuit and/or data processing device. The memory 12, 22, or 32 may include read-only memory (ROM), random access memory (RAM), flash memory, memory card, storage medium and/or other storage device. The transceiver 13, 23, or 33 may include baseband circuitry to process radio frequency signals. When the embodiments are implemented in software, the techniques described herein can be implemented with modules (e.g., procedures, functions, and so on) that perform the functions described herein. The modules can be stored in the memory 12, 22, or 32 and executed by the processor 11, 21, or 31. The memory 12, 22, or 32 can be implemented within the processor 11, 21, or 31 or external to the processor 11, 21, or 31 in which case those can be communicatively coupled to the processor 11, 21, or 31 via various means as is known in the art.

In some embodiments, the processor 11 is configured to determine an AI/ML model specific reference signal configuration, wherein the AI/ML model specific reference signal configuration comprises an indication to indicate a reference signal usage of an AI/ML model specific reference signal, and the reference signal usage comprises at least one of the following: AI/ML functionality, AI/ML model, AI/ML model procedure, and/or AI/ML scenario. This can solve the issues in the prior art, reduce a signaling overhead, provide scalability to different models' requirement for one AI/ML model type, and unify one-side model or two-side model's procedure with a single AI/ML model specific process.

In some embodiments, the processor 21 is configured to configure to the UE 10, an AI/ML model specific reference signal configuration, wherein the AI/ML model specific reference signal configuration comprises an indication to indicate a reference signal usage of an AI/ML model specific reference signal, and the reference signal usage comprises at least one of the following: AI/ML functionality, AI/ML model, AI/ML model procedure, and/or AI/ML scenario. This can solve the issues in the prior art, reduce a signaling overhead, provide scalability to different models' requirement for one AI/ML model type, and unify one-side model or two-side model's procedure with a single AI/ML model specific process.

In some embodiments, the transceiver 13 is configured to receive from the network device 20, a downlink AI/ML model specific reference signal configuration. The downlink AI/ML model specific reference signal configuration comprises a resource type indication used to indicate at least one of the following: an identifier of the AI/ML model; an identifier of the AI/ML type; an identifier of the AI/ML functionality; an identifier of the AI/ML model procedure; an identifier of the AI/ML scenario; and/or an identifier of the reference signal. The transceiver 13 is further configured to transmit to the network device 20, a downlink AI/ML model specific channel state information (CSI)/reporting/feedback. This can solve the issues in the prior art, reduce a signaling overhead, provide scalability to different models' requirement for one AI/ML model type, and unify one-side model or two-side model's procedure with a single AI/ML model specific process.

In some embodiments, the transceiver 13 is configured to receive from the network device 20, an uplink AI/ML model specific reference signal configuration. The uplink AI/ML model specific reference signal configuration comprises a resource type indication used to indicate at least one of the following: an identifier of the AI/ML model; an identifier of the AI/ML type; an identifier of the AI/ML functionality; an identifier of the AI/ML model procedure; an identifier of the AI/ML scenario; and/or an identifier of the reference signal. The transceiver 13 is further configured to receive from the network device 20, an uplink AI/ML model specific channel state information (CSI)/reporting/feedback. The transceiver 13 is further configured to receive from the network device 20, a feedback of an AI/ML model specific information. This can solve the issues in the prior art, reduce a signaling overhead, provide scalability to different models' requirement for one AI/ML model type, and unify one-side model or two-side model's procedure with a single AI/ML model specific process.

In some embodiments, the transceiver 23 is configured to transmit to the user equipment (UE) 10, a downlink AI/ML model specific reference signal configuration. The downlink AI/ML model specific reference signal configuration comprises a resource type indication used to indicate at least one of the following: an identifier of the AI/ML model; an identifier of the AI/ML type; an identifier of the AI/ML functionality; an identifier of the AI/ML model procedure; an identifier of the AI/ML scenario; and/or an identifier of the reference signal. The transceiver 23 is further configured to receive from the UE 10, a downlink AI/ML model specific channel state information (CSI)/reporting/feedback. This can solve the issues in the prior art, reduce a signaling overhead, provide scalability to different models' requirement for one AI/ML model type, and unify one-side model or two-side model's procedure with a single AI/ML model specific process.

In some embodiments, the transceiver 23 is configured to transmit to the user equipment (UE) 10, an uplink AI/ML model specific reference signal configuration. The uplink AI/ML model specific reference signal configuration comprises a resource type indication used to indicate at least one of the following: an identifier of the AI/ML model; an identifier of the AI/ML type; an identifier of the AI/ML functionality; an identifier of the AI/ML model procedure; an identifier of the AI/ML scenario; and/or an identifier of the reference signal. The transceiver 23 is further configured to transmit to the UE 10, an uplink AI/ML model specific channel state information (CSI)/reporting/feedback, and the transceiver 23 is further configured to feedback, to the UE 10, an AI/ML model specific information. This can solve the issues in the prior art, reduce a signaling overhead, provide scalability to different models' requirement for one AI/ML model type, and unify one-side model or two-side model's procedure with a single AI/ML model specific process.

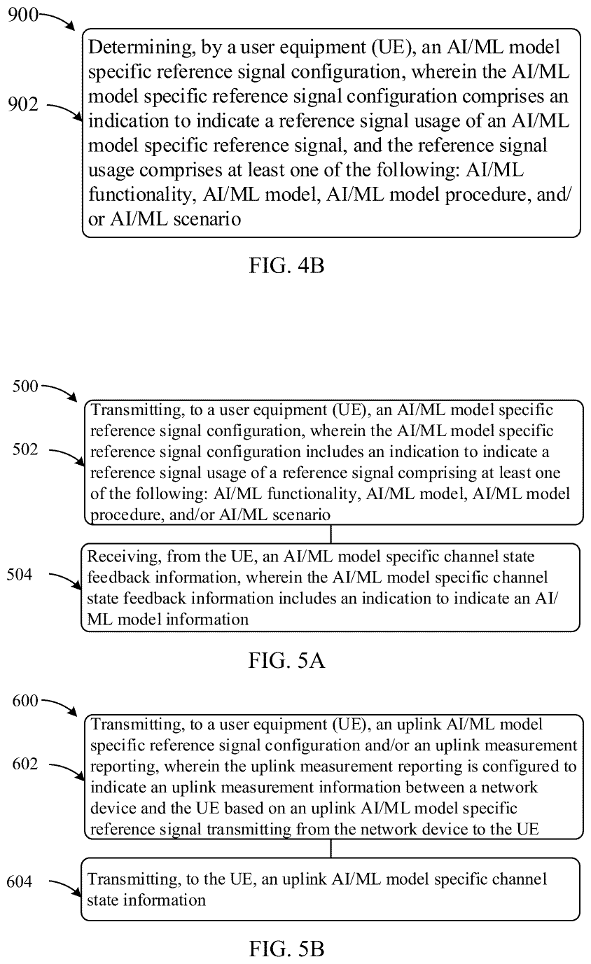

FIG. 4A is a flowchart illustrating a wireless communication method 800 of artificial intelligence (AI)/machine learning (ML) according to an embodiment of the present disclosure. In some embodiments, the method 800 includes: a block 802, configurating, to a user equipment (UE), an AI/ML model specific reference signal configuration, wherein the AI/ML model specific reference signal configuration comprises an indication to indicate a reference signal usage of an AI/ML model specific reference signal, and the reference signal usage comprises at least one of the following: AI/ML functionality, AI/ML model, AI/ML model procedure, and/or AI/ML scenario. This can solve the issues in the prior art, reduce a signaling overhead, provide scalability to different models' requirement for one AI/ML model type, and unify one-side model or two-side model's procedure with a single AI/ML model specific process.

FIG. 4B is a flowchart illustrating a wireless communication method 900 of artificial intelligence (AI)/machine learning (ML) according to an embodiment of the present disclosure. In some embodiments, the method 900 includes: a block 902, determining, by a user equipment (UE), an AI/ML model specific reference signal configuration, wherein the AI/ML model specific reference signal configuration comprises an indication to indicate a reference signal usage of an AI/ML model specific reference signal, and the reference signal usage comprises at least one of the following: AI/ML functionality, AI/ML model, AI/ML model procedure, and/or AI/ML scenario. This can solve the issues in the prior art, reduce a signaling overhead, provide scalability to different models' requirement for one AI/ML model type, and unify one-side model or two-side model's procedure with a single AI/ML model specific process.

FIG. 5A is a flowchart illustrating a wireless communication method 500 of artificial intelligence (AI)/machine learning (ML) according to an embodiment of the present disclosure. In some embodiments, the method 500 includes: a block 502, transmitting, to a user equipment (UE), an AI/ML model specific reference signal configuration, wherein the AI/ML model specific reference signal configuration includes an indication to indicate a reference signal usage of a reference signal comprising at least one of the following: AI/ML functionality, AI/ML model, AI/ML model procedure, and/or AI/ML scenario, and/or a block 504, receiving, from the UE, an AI/ML model specific reporting information configuration, wherein the AI/ML model specific reporting information configuration includes an indication to indicate an AI/ML model information. This can solve the issues in the prior art, reduce a signaling overhead, provide scalability to different models' requirement for one AI/ML model type, and unify one-side model or two-side model's procedure with a single AI/ML model specific process.

In some examples, the indication to indicate the reference signal usage comprises at least one of the followings: an identifier of the AI/ML model; an identifier of the AI/ML type; an identifier of the AI/ML functionality; an identifier of the AI/ML scenario; an identifier of the AI/ML model procedure; an identifier of the reference signal; and an order-based indication. In some examples, through the order-based indication, AI/ML related reference signals are indicated with different configured orders. In some examples, the reference signal comprises at least one of the following: channel state information-reference signal (CSI-RS), demodulation reference signal (DMRS), sounding reference signal (SRS), phase tracking reference signal (PTRS), and/or positioning reference signal (PRS).

In some examples, the indication to indicate the AI/ML model specific reporting information configuration comprises at least one of the following: an identifier of the AI/ML model; an identifier of the AI/ML type; an identifier of the AI/ML functionality; an identifier of the AI/ML scenario; an identifier of the AI/ML model procedure; and an identifier of the reference signal. In some examples, the AI/ML model specific reference signal configuration and/or the AI/ML model specific reporting information configuration are active/de-active by a triggering information, wherein the triggering information comprises at least one of the following: an identifier of the AI/ML model; an identifier of the AI/ML type; an identifier of the AI/ML functionality; an identifier of the AI/ML scenario; an identifier of the AI/ML model procedure; an identifier of the reference signal; an identifier of a reporting quantity; active timing; and/or de-active timing.

FIG. 5B is a flowchart illustrating a wireless communication method 600 of artificial intelligence (AI)/machine learning (ML) according to an embodiment of the present disclosure. In some embodiments, the method 600 includes: a block 602, transmitting, to a user equipment (UE), an uplink AI/ML model specific reference signal configuration and/or an uplink measurement reporting, wherein the uplink measurement reporting is configured to indicate an uplink measurement information between a network device and the UE based on an uplink AI/ML model specific reference signal transmitting from the network device to the UE, and/or a block 604, transmitting, to the UE, an uplink AI/ML model specific channel state information. This can solve the issues in the prior art, reduce a signaling overhead, provide scalability to different models' requirement for one AI/ML model type, and unify one-side model or two-side model's procedure with a single AI/ML model specific process.

In some examples, the uplink AI/ML model specific reference signal configuration and/or the uplink measurement reporting comprises an indication to indicate a reference signal usage of the reference signal, and the indication to indicate the reference signal usage comprises at least one of the following: an identifier of the AI/ML model; an identifier of the AI/ML type; an identifier of the AI/ML functionality; an identifier of the AI/ML scenario; an identifier of the AI/ML model procedure; an identifier of the reference signal; and/or an order-based indication. In some examples, through the order-based indication, AI/ML related reference signals are indicated with different configured orders. In some examples, the reference signal comprises at least one of the following: channel state information-reference signal (CSI-RS), demodulation reference signal (DMRS), sounding reference signal (SRS), phase tracking reference signal (PTRS), and/or positioning reference signal (PRS). In some examples, n the uplink AI/ML model specific channel state information comprises at least one of the following: an identifier of the AI/ML model; an identifier of the AI/ML type; an identifier of the AI/ML functionality; an identifier of the AI/ML scenario; an identifier of the AI/ML model procedure; and/or an identifier of the reference signal.

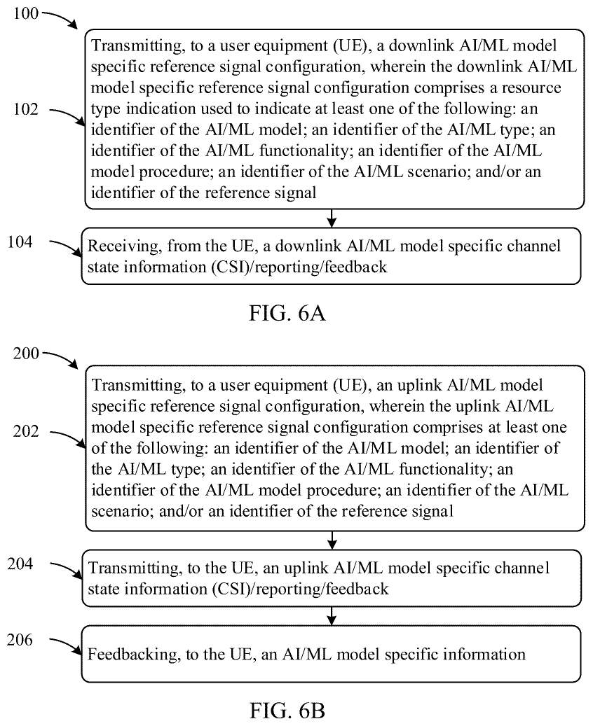

FIG. 6A is a flowchart illustrating a wireless communication method 100 of artificial intelligence (AI)/machine learning (ML) by a network device according to an embodiment of the present disclosure. In some embodiments, the method 100 includes: a block 102, transmitting, to a user equipment (UE), a downlink AI/ML model specific reference signal configuration, wherein the downlink AI/ML model specific reference signal configuration comprises a resource type indication used to indicate at least one of the following: an identifier of the AI/ML model; an identifier of the AI/ML type; an identifier of the AI/ML functionality; an identifier of the AI/ML model procedure; an identifier of the AI/ML scenario; and/or an identifier of the reference signal, and a block 104, receiving, from the UE, a downlink AI/ML model specific channel state information (CSI)/reporting/feedback. This can solve the issues in the prior art, reduce a signaling overhead, provide scalability to different models' requirement for one AI/ML model type, and unify one-side model or two-side model's procedure with a single AI/ML model specific process.

FIG. 6B is a flowchart illustrating a wireless communication method 200 of artificial intelligence (AI)/machine learning (ML) by a network device according to an embodiment of the present disclosure. In some embodiments, the method 200 includes: a block 202, transmitting, to a user equipment (UE), an uplink AI/ML model specific reference signal configuration, wherein the uplink AI/ML model specific reference signal configuration comprises at least one of the following: an identifier of the AI/ML model; an identifier of the AI/ML type; an identifier of the AI/ML functionality; an identifier of the AI/ML model procedure; an identifier of the AI/ML scenario; and/or an identifier of the reference signal, a block 204, transmitting, to the UE, an uplink AI/ML model specific channel state information (CSI)/reporting/feedback, and a block 206, feedbacking, to the UE, an AI/ML model specific information. This can solve the issues in the prior art, reduce a signaling overhead, provide scalability to different models' requirement for one AI/ML model type, and unify one-side model or two-side model's procedure with a single AI/ML model specific process.

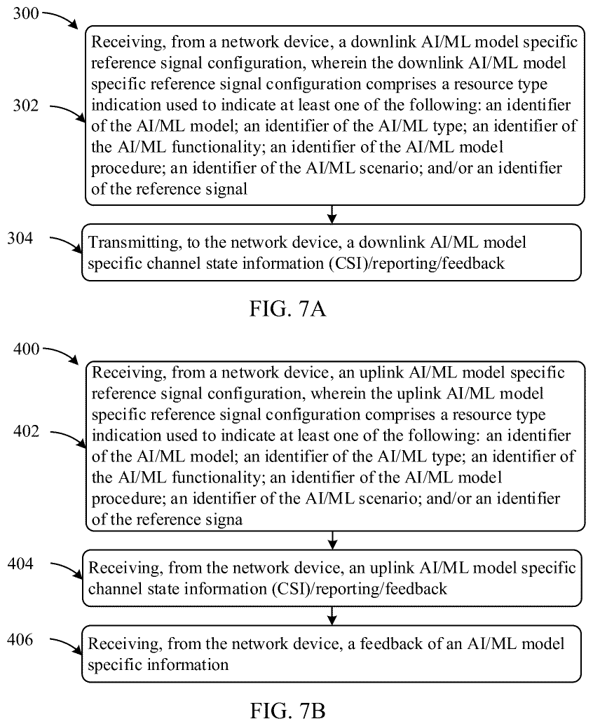

FIG. 7A is a flowchart illustrating a wireless communication method 300 of artificial intelligence (AI)/machine learning (ML) by a UE according to an embodiment of the present disclosure. In some embodiments, the method 300 includes: a block 302, receiving, from a network device, a downlink AI/ML model specific reference signal configuration, wherein the downlink AI/ML model specific reference signal configuration comprises a resource type indication used to indicate at least one of the following: an identifier of the AI/ML model; an identifier of the AI/ML type; an identifier of the AI/ML functionality; an identifier of the AI/ML model procedure; an identifier of the AI/ML scenario; and/or an identifier of the reference signal, and a block 304, transmitting, to the network device, a downlink AI/ML model specific channel state information (CSI)/reporting/feedback. This can solve the issues in the prior art, reduce a signaling overhead, provide scalability to different models' requirement for one AI/ML model type, and unify one-side model or two-side model's procedure with a single AI/ML model specific process.

FIG. 7B is a flowchart illustrating a wireless communication method 400 of artificial intelligence (AI)/machine learning (ML) by a UE according to an embodiment of the present disclosure. In some embodiments, the method 400 includes: a block 402, receiving, from a network device, an uplink AI/ML model specific reference signal configuration, wherein the uplink AI/ML model specific reference signal configuration comprises a resource type indication used to indicate at least one of the following: an identifier of the AI/ML model; an identifier of the AI/ML type; an identifier of the AI/ML functionality; an identifier of the AI/ML model procedure; an identifier of the AI/ML scenario; and/or an identifier of the reference signal, a block 404, receiving, from the network device, an uplink AI/ML model specific channel state information (CSI)/reporting/feedback, and a block 406, receiving, from the network device, a feedback of an AI/ML model specific information. This can solve the issues in the prior art, reduce a signaling overhead, provide scalability to different models' requirement for one AI/ML model type, and unify one-side model or two-side model's procedure with a single AI/ML model specific process.

To combine the AI/ML model information with the reference signaling and CSI measurement/reporting both for downlink and uplink, the following overall solutions have been proposed in some embodiments of this disclosure, as shown in the following figures, the downlink and uplink overall solutions are presented for different AI/ML models (one-side, two sides, positioning, beam management, CSI compression, model inference/monitoring, etc.).

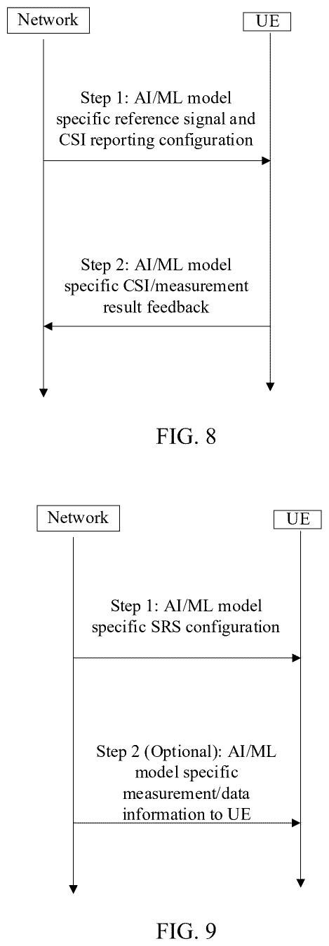

FIG. 8 is a flowchart illustrating downlink AI/ML model specific resource configuration and feedback according to an embodiment of the present disclosure. FIG. 8 illustrates that, in some embodiments, two steps are disclosed. In Step 1: The network transmits AI/ML model specific reference signal and CSI reporting configuration to the UE. In Step 2: The UE transmits AI/ML model specific CSI/measurement result feedback to the network. FIG. 8 further illustrates that, in some embodiments, for the downlink configuration, AI/ML-model specific reference signal is adopted, which includes but not limited to the CSI-RS, SSB, PRS, DMRS, etc. Corresponding to the AI/ML-model specific reference signal, the AI/ML-model specific measurement and reporting results are proposed to support network-side AI/ML, and the reporting results can be empty to support UE-side training or inference, etc.

FIG. 9 is a flowchart illustrating uplink AI/ML model specific resource configuration and feedback according to an embodiment of the present disclosure. FIG. 9 illustrates that, in some embodiments, two steps are disclosed. In Step 1: The network transmits AI/ML model specific SRS configuration to the UE. In Step 2 (Optional): The network transmits AI/ML model specific measurement/data information to the UE. FIG. 9 further illustrates that, in some embodiments, for the uplink configuration similar to the downlink AI/ML-model specific reference signal configuration, uplink AI/ML-model specific SRS reference signal is defined in the system. Further, compared with the legacy SRS resource configuration has noncorresponding CSI feedback from the network to the UE, additional uplink CSI feedback to the UE have been involved here, so as to support UE-only located AI/ML model (training, inference, monitoring, etc.), also for two side AI/ML model, such as AI-based modulation/coding/decoding, etc.

Furthermore, the detail signal procedure to support the overall solutions as shown in following embodiments, and the downlink and uplink AI/ML model specific configuration and reporting is involved here.

### Downlink AI/ML-Model Specific Signaling

1) Network device (e.g., gNB, AP etc.) sends the AI/ML model specific reference signaling (e.g., CSI-RS, SSB, DMRS, PRS, PTRS, etc.) configuration and associated reporting configuration to the UE. The implementation methods are as shown in the following embodiments 1 and 2.

2) The UE receives the network configuration from RRC or MAC-CE signaling and performs measurement according to the configured reference signaling and reporting elements. The implementation method is as shown in the following embodiment 3.

3) The UE feedbacks the measurement results that have been required by reporting configuration, and the UE transmits to the network device with PUCCH or PUSCH or msg2/4 message. The implementation method is as shown in the following embodiment 2.

### Uplink AI/ML Model Specific Signaling

1) The network device (e.g., gNB, AP etc.) sends the AI/ML model specific reference signal resource configuration (including SRS, DMRS, etc.) and associated feedback information configuration to the UE, and the implementation methods are as shown in the following embodiments 4 and 5.

2) The UE receives the network configuration from RRC or MAC-CE signaling, and the UE sends the SRS according to the configured timing and frequency information. The implementation method is as shown in the following embodiment 3.

3) The Network device can perform measurement according to the SRS signal and required feedback information.

4) The Network device transmits the AI/ML model specific measurement results to the UE, and the implementation method is as shown in the following embodiment 5.

### EMBODIMENTS

### Embodiment 1: Downlink AI/ML Model Specific Reference Signal Configuration

In addition to those legacy reference signals defined by Rel.15, Rel.16, Rel.17, and/or Rel.18, new reference signal resource type would be defined to support various AI/ML model's regular operation in the wireless system. One mark can be added to the reference signal, by which the U can distinguish the usage of the configuration reference signal, for non-AI/ML based measurement or AI/ML based measurement, etc. In an example, one AI/ML model specific resource type is used and indication to UE side, the resource type can be denoted as string, ID, or reference signal name, the detail implementation as shown in table 2.

In some examples, a base station configurates, to a user equipment (UE), an AI/ML model specific reference signal configuration such as a downlink AI/ML model specific reference signal configuration, wherein the AI/ML model specific reference signal configuration comprises an indication to indicate a reference signal usage of an AI/ML model specific reference signal, and the reference signal usage comprises at least one of the following: AI/ML functionality, AI/ML model, AI/ML model procedure, and/or AI/ML scenario.

In some examples, the indication to indicate the reference signal usage comprises at least one of the followings: an identifier of the AI/ML model; an identifier of the AI/ML type; an identifier of the AI/ML functionality; an identifier of the AI/ML scenario; an identifier of the AI/ML model procedure; an identifier of the reference signal; and an order-based indication. In some examples, through the order-based indication, AI/ML related reference signals are indicated with different configured orders.

TABLE 2
Direct downlink AI/ML model specific reference signal configuration

| Resource type | Detail |
|---|---|
| indication method | description |
| String | String is used to distinguish the reference signal type, for example, |
| | “Non-AI/ML model based” which means the configuration is for |
| | CSI measurement without the AI-mode. |
| | “AI/ML model based” which means the configuration is used for |
| | AI/ML model based operation, including the AI/ML model |
| | training/monitoring, also the CSI feedback. |
| ID | ID is used to distinguish the reference signal type, for example, |
| | 0: the configuration is for CSI measurement without the AI-mode. |
| | 1: used for AI/ML model based operation, including the AI/ML |
| | model training/monitoring, also the CSI feedback. |
| Reference signal | Reference signal name is used to distinguish the reference signal |
| name | type, for example, |
| | CSI-RS resource/resource set/resource setting: the configuration |
| | is for CSI measurement without the AI-mode. |
| | AI mode CSI-RS resource/resource set/resource setting: used for |
| | AI/ML model based operation, including the AI/ML model |
| | training/monitoring, also the CSI feedback. |

In the table 2, for examples, resource type indication method includes string, ID, reference signal name indications, etc. String is used to distinguish the reference signal type such as non-AI/ML model based type and AI/ML model based type. ID 0 means that the configuration is for CSI measurement without the AI-mode. ID 1 means that the configuration is used for AI/ML model based operation, including the AI/ML model training/monitoring, also the CSI feedback. Reference signal name indication may include CSI-RS resource/resource set/resource setting and AI mode CSI-RS resource/resource set/resource setting.

Furthermore, considering there is more than one AI/ML model used for different purposes, such as positioning, CSI compression, beam management, etc. Table 2's definition needs to be further classified so as to support various AI/ML models (Functionalities), which also can be denoted as string, ID, bitmap, or reference signal name, the detailed implementation is shown in table 3.

TABLE 3
Direct signaling to distinguish AI functionalities

| Resource type | Detail |
|---|---|
| indication method | description |
| String | The string is used to distinguish the AI functionalities, for example, |
| | “Positioning AI/ML model based” which means the configuration is |
| | for position with AI/ML model operations. |
| | The same logic for “beam management”, “CSI compression”, etc. |
| ID | ID is used to distinguish the AI functionalities, for example, |
| | 1: the configuration is for position with AI/ML model operations. |
| | 2: the configuration is for beam management with AI/ML model |
| | operations. |
| | The same logic for other AI/ML based functionalities. |
| Bitmap | The bitmap is used to distinguish the AI functionalities, each bit |
| | represents a specific AI function, 0 means invalid but reverse when it's 1, |
| | for example, |
| | “1000”: the last bit is “1”, which means the configuration is used for |
| | position with AI/ML model operations. |
| | The same logic for other AI/ML based functionalities. |
| Reference | Reference signal name is used to distinguish the AI functionalities, for |
| signal name | example, |
| | AI positioning CSI-RS resource/resource set/resource setting: used |
| | for position with AI/ML model operations. |
| | The same logic for other AI/ML based functionalities. |

In the table 3, for examples, resource type indication method includes string, ID, bitmap, reference signal name indications, etc. The string is used to distinguish the AI functionalities such as “positioning AI/ML model based” which means the configuration is for position with AI/ML model operations, and the same logic for “beam management”, “CSI compression”, etc. ID1: the configuration is for position with AI/ML model operations. ID2: the configuration is for beam management with AI/ML model operations. The same logic for other AI/ML based functionalities. The bitmap is used to distinguish the AI functionalities, each bit represents a specific AI function. Reference signal name is used to distinguish the AI functionalities and may include AI positioning CSI-RS resource/resource set/resource setting, etc.

Also, for one AI function, several procedures have been defined, including data collection, inference, monitoring, and training. The indication also would be AI/ML model procedure, which is associated with different procedure for one AI function, and it can be denoted by string, ID or Bitmap or other method. Taking the bitmap for example, “0001” means the configuration used for training, “0010” means the configuration used for monitoring, “0100” means the configuration used for inference, “1000” means the configuration is used for data collection etc.

Moreover, there would have several AI/ML models for one specific AI function, the resource type would be structured with hierarchical methodology to fulfill different scenarios, as shown in following table 4.

TABLE 4
Direct signaling to distinguish AI functionalities

| Description | Content info #1 | Content info #2 | Content info #3 |
|---|---|---|---|
| Function | Denoting whether it's AI | Denoting what AI | Denoting which AI/ML |
| definition | or Non AI-mode Based, | functionalities would be | model type would be used |
| | for the configuration/ | used for the specific | for one specific AI |
| | measurement/reporting | operation, including the | function, taking the CSI |
| | etc., this item | configuration/measurement/ | compression for example, |
| | would be optional. | reporting, etc. | the Model #1 is more |
| | | | accurate than Model #2, |
| | | | but Model #1 needs more |
| | | | computation resource |
| | | | than Model #2. |
| | | | Therefore, model type |
| | | | distinguish info is needed |
| | | | for indication. |
| ID-based | 0: Non AI/ML model | 0: Positioning AI/ML | 0: model 1 in function A; |
| indication | based; | model; | |
| | 1: AI/ML model based; | 1: Beam management | 1: model 2 in function A; |
| | | AI/ML model; | |
| | | 2: CSI enhancement | 2: model 3 in function A. |
| | | AI/ML model. | |
| | 0: Non AI/ML model | 0: Positioning AI/ML | Classifying different |
| | based; | model; | AI/ML models into |
| | 1: AI/ML model based. | 1: Beam management | different level according |
| | | AI/ML model; | to the input, output, |
| | | 2: CSI enhancement | computation/power |
| | | AI/ML model. | requirement, KPIs, etc. |
| | | | for example, level 1 |
| | | | including model 1 and |
| | | | model 3; level 2 including |
| | | | model 2 and model 4. |
| | | | 0: level 1 in function A; |
| | | | 1: level 2 in function A; |
| | | | 2: level 3 in function A. |
| Bitmap- | 0: Non AI/ML model | “000”: Positioning | “000”: model 1 in |
| based | based; | AI/ML model; | function A; |
| indication | 1: AI/ML model based. | “010”: Beam | “001”: model 2 in |
| | | management AI/ML | function A; |
| | | model; | “100”: model 3 in |
| | | “100”: CSI enhancement | function A. |
| | | AI/ML model; | |
| | | “101”: Both CSI and | |
| | | positioning AI/ML model. | |
| | 0: Non AI/ML model | “000”: Positioning | Model level based |
| | based; | AI/ML model; | indication |
| | 1: AI/ML model based. | “010”: Beam | “000”: level 1 in |
| | | management AI/ML | function A; |
| | | model; | “001”: level 1 in |
| | | “100”: CSI enhancement | function A; |
| | | AI/ML model; | “100”: level 1 in |
| | | “101”: Both CSI and | function A. |
| | | positioning AI/ML model. | |

In table 4, in some examples, use function definition, ID-based indication, bitmap-based indication and their content info #1, content info #2, and content info #3 to distinguish AI functionalities. Take ID-based indication and its content info #1, content info #2, and content info #3 as an example, in the content info #1, ID 0 means non AI/ML model based, and ID 1 means AI/ML model based, in the content info #2, ID 0 means positioning AI/ML model, ID 1 means beam management AI/ML model, and ID 2 means CSI enhancement AI/ML model, and in the content info #3, ID 0 means model 1 in function A, ID 1 means model 2 in function A, and ID 2 means model 3 in function A. This can distinguish AI functionalities.

In some examples, the AI/ML model specific reference signal comprises at least one of following: channel state information-reference signal (CSI-RS), demodulation reference signal (DMRS), sounding reference signal (SRS), phase tracking reference signal (PTRS), positioning reference signal (PRS)

Except for those methodologies mentioned above, with direct indication to info UE of the usage of the configuration, also the implicit indication method should be considered, as shown in the followings.

IE

```
  -- ASN1START
  -- TAG-CSI-REPORTCONFIG-START
```

| CSI-ReportConfig ::= | SEQUENCE { | |
|---|---|---|
| reportConfigId | CSI-ReportConfigId, | |
| carrier | ServCellIndex | OPTIONAL, -- Need S |
| resourcesForChannelMeasurement | CSI-ResourceConfigId, | |
| csi-IM-ResourcesForInterference | CSI-ResourceConfigId | OPTIONAL, -- |

Need R

| | | |
|---|---|---|
| nzp-CSI-RS-ResourcesForInterference | CSI-ResourceConfigId | OPTIONAL, |

-- Need R

| | |
|---|---|
| Position-AI-Resourceformeasurement | CSI-ResourceConfigId |
| Beammanagement-AI-Resourceformeasurement | CSI-ResourceConfigId |

```
  ......
  }
  -- TAG-CSI-REPORTCONFIG-STOP
-- ASN1STOP
```

In embodiment 1, the configuration order is used to distinguish the reference signal's usage, just taking the CSI-RS for example, but the same for other reference signals, the first resource configuration is used for non-AI/ML based channel measurement; the second resource configuration is used for interference measurement with CSI-IM resource; the third resource configuration is used for NZP-CSI-RS based interference measurement; the fourth resource configuration is used for AI/ML model based CSI operation (measurement, monitoring etc.); the fifth resource configuration is used for AI/ML model based beam management operation (measurement, monitoring, etc.) In some examples, through the order-based indication, AI/ML related reference signals of the AI/ML model specific reference signal configuration are indicated with different configured orders.

### Embodiment 2: Downlink AI/ML Model Specific CSI/Reporting/Feedback to Network

In some examples, the base station receives from the UE an AI/ML model specific reporting information configuration (or the UE transmits the AI/ML model specific reporting information configuration to the base station), wherein the AI/ML model specific reporting information configuration comprises an indication to indicate an AI/ML model information. The AI/ML model specific reporting information configuration includes, for example, a downlink AI/ML model specific CSI/reporting/feedback. In some examples, the indication to indicate the AI/ML model information comprises: at least one of the following: an identifier of the AI/ML model; an identifier of the AI/ML type; an identifier of the AI/ML functionality; an identifier of the AI/ML scenario; an identifier of the AI/ML model procedure; and/or an identifier of the reference signal.

For the AI/ML model specific information feedback requirement, there would have several methods to distinguish the AI function's requirement, which as shown in the followings.

1) Dedicated reporting quantity had been defined, which used for AI/ML model specific operation.

2) Dedicated reporting configuration, in which AI/ML model specific information is included.

3) Dedicated measurement configuration, in which AI/ML model specific information is included.

4) For the 2) and 3), where the AI/ML model specific information may be indicated as AI/ML model ID, AI mode type, AI/ML model functionality, AI/ML model procedure, etc.

Especially for the 1) implementation method, similar as the current defined reporting configuration, one dedicated report quantity had been defined and dedicated for AI/ML model operation, and under the A-specific report quantity, functionality-specific reporting information is included here, the example data structure and detail description as shown in followings.

IE

| -- ASN1START | |
|---|---|
| -- TAG-CSI-REPORTCONFIG-START | |
| CSI-ReportConfig ::= | SEQUENCE { |
| ...... | |
| reportQuantity | CHOICE {...... }, |
| reportQuantity-r16 | CHOICE {...... }, |
| reportQuantity-r17 | CHOICE {...... }, |
| reportQuantity-AI | CHOICE { |
| None | NULL, |
| Positioning | CHOICE {...... }, |
| Beammanagment | CHOICE {...... }, |
| CSI | CHOICE {...... }, |

```
  },
  ......
  }
  -- TAG-CSI-REPORTCONFIG-STOP
-- ASN1STOP
```

None: which means the UE don't need to feedback, it's mainly used for UE-side AI/ML model's training, monitoring, updating/switching/fallback, inference, or other usage.

Positioning: The necessary feedback information for the AI/ML model based position and the AI/ML model specific information are in network side, where the AI/ML model specific information may be indicated as AI/ML model ID, AI mode type, AI/ML model functionality, or reference signal index (CSI-RS resource index, DMRS resource index, SSB resource index), etc.

Beam management: The necessary feedback information for the AI/ML model based management and AI/ML model specific information are in network side, where the AI/ML model specific information may be indicated as AI/ML model ID, AI mode type, AI/ML model functionality, or reference signal index (CSI-RS resource index, DMRS resource index, SSB resource index), etc.

CSI: The necessary feedback information for the AI/ML model based CSI and AI/ML model specific information are in network side, where the AI/ML model specific information may be indicated as AI/ML model ID, AI mode type, AI/ML model functionality, or reference signal index (CSI-RS resource index, DMRS resource index, SSB resource index), etc.

### Embodiment 3: On-Demand Downlink AI/ML Model Specific Operation Triggering

In some examples, the AI/ML model specific reference signal configuration and/or the AI/ML model specific reporting information configuration are active/de-active by a triggering information.

Considering the UE's power and computation resource limitation capability, the AI/ML model operation would be active on some specific scenarios, therefore, the aperiodic or semi-static on-demand operation is required for reference signal transmission and measurement or reporting. In order to decrease the air interface overhead, the following information would be carried by MAC-CE or PDCCH or RRC signaling.

1) Active/de-active information is used for specific AI/ML model, which is carried by MAC-CE or PDCCH.

2) AI/ML model specific active/de-active timing is used and would be predefined or carried by MAC-CE/RRC.

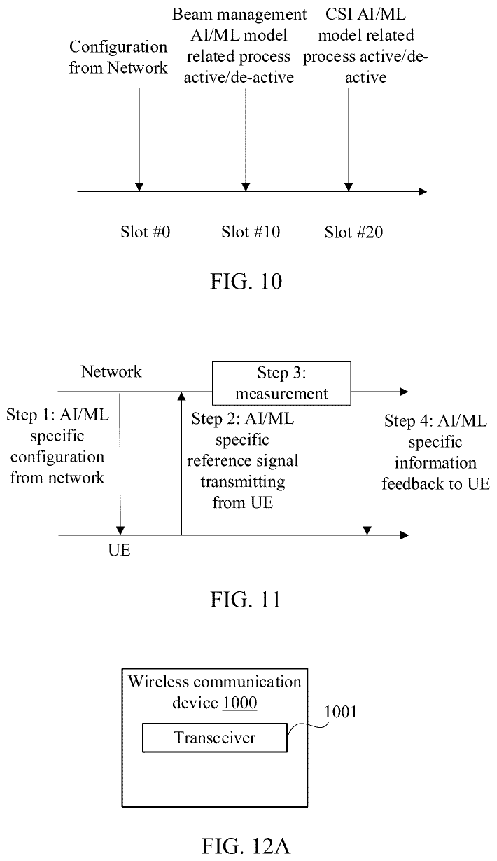

For 1), the indication information can be bitmap, AI/ML model ID, AI/ML model type, or AI functionality name. Taking the bitmap for example, assume there have 4 AI/ML models in system (positioning, beam management, CSI-1, CSI-2, etc.), if the bitmap is organized as “1111”, which means all those AI/ML models are active; if bitmap equal to “0000”, which means no AI/ML models would be used in the system. For the 2), the active/de-active timing is AI/ML model specific, for example, beam management AI/ML model's active timing is 10 slots and 10 slots for de-active; but for CSI AI/ML model, it's active timing is 20 slots and 20 slots for de-active, due to need longer time for data collection, etc. Moreover, there would have multiple AI/ML models to perform the same function, and the active/de-active timing would be difference from model ID, as shown in FIG. 10. In some examples, the triggering information comprises at least one of the following: an identifier of the AI/ML model; an identifier of the AI/ML type; an identifier of the AI/ML functionality; an identifier of the AI/ML scenario; an identifier of the reference signal; an identifier of the AI/ML model procedure; an identifier of a reporting quantity; active timing; and/or de-active timing.

FIG. 10 is a schematic diagram illustrating AI/ML model specific active/de-active timing according to an embodiment of the present disclosure. FIG. 10 illustrates that, in some embodiments, in slot #1, the UE receives a configuration from the network device, in slot #10, beam management AI/ML model's active timing is 10 slots and 10 slots for de-active, and in slot #20, for CSI AI/ML model, it's active timing is 20 slots and 20 slots for de-active, due to need longer time for data collection, etc.

### Embodiment 4: Uplink AI/ML Model Specific Reference Signal Configuration

In some examples, abase station configurates, to a user equipment (UE), an AI/ML model specific reference signal configuration such as a uplink AI/ML model specific reference signal configuration, wherein the AI/ML model specific reference signal configuration comprises an indication to indicate a reference signal usage of an AI/ML model specific reference signal, and the reference signal usage comprises at least one of the following: AI/ML functionality, AI/ML model, AI/ML model procedure, and/or AI/ML scenario.

In some examples, the indication to indicate the reference signal usage comprises at least one of the followings: an identifier of the AI/ML model; an identifier of the AI/ML type; an identifier of the AI/ML functionality; an identifier of the AI/ML scenario; an identifier of the AI/ML model procedure; an identifier of the reference signal; and an order-based indication. In some examples, through the order-based indication, AI/ML related reference signals are indicated with different configured orders.

For the legacy uplink reference configuration, take the SRS for example and its data structure as shown in the followings, except the general information, such as resource set/resource/timing/comb, etc. The usage of SRS had been introduced in Rel.17, for the usage item, it indicates if the SRS resource set is used for beam management, codebook based, or non-codebook based transmission or antenna switching, and for the usage PDC, it indicates that this SRS resource set is used for propagation delay compensation.

IE

| | |
|---|---|
| SRS-ResourceSet ::= | SEQUENCE { |
| srs-ResourceSetId | SRS-ResourceSetId, |
| srs-ResourceIdList | SEQUENCE (SIZE(1..maxNrofSRS-ResourcesPerSet)) |
| resourceType | CHOICE { ... } |
| usage | ENUMERATED {beamManagement, codebook, nonCodebook, |

antennaSwitching},

| | |
|---|---|
| usagePDC-r17 | ENUMERATED {true} |

......
}

Similar as the downlink AI/ML model specific reference signal interaction, one mark can be added to the reference signal, by which the UE can distinguish the transmitting method for the configuration reference signal, for non-AI based measurement or AI/ML based measurement etc. In an example, one AI/ML model specific resource type is used and indication to UE side, the resource type can be denoted as string, ID, or reference signal name, the detail implementation as shown in table 5.

TABLE 5
Direct downlink AI/ML model specific reference signal configuration

| Resource type | Detail |
|---|---|
| indication method | description |
| String | String is used to distinguish the reference signal type or usage, for |
| | example, |
| | “Non-AI/ML model based” which means the configuration is for |
| | legacy mode; |
| | “AI/ML model based” which means the configuration is used for |
| | AI/ML model based operation, including the AI/ML model |
| | training/monitoring. |
| ID | ID is used to distinguish the reference signal type, for example, |
| | 0: the configuration is for legacy mode; |
| | 1: used for AI/ML model based operation, including the AI/ML |
| | model training/monitoring. |

In table 5, resource type indication method may include string and ID indications, etc. String is used to distinguish the reference signal type or usage such as non-AI/ML model based type and AI/ML model based type. ID 0 may mean that the configuration is for legacy mode, and ID 1 is used for AI/ML model based operation, including the AI/ML model training/monitoring.

Furthermore, considering there is more than one AI/ML model used for different purposes, such as positioning, CSI compression, beam management etc. The table 5's definition needs to be further classified so as to support various AI/ML models (functionalities), which also can be denoted as string, ID, bitmap, or reference signal name, the detail implementation is as shown in table 6.

TABLE 6
Direct signaling to distinguish AI functionalities

| Resource type | Detail |
|---|---|
| indication method | description |
| String | String is used to distinguish the AI functionalities, for example, |
| | “Positioning AI/ML model based” which means the configuration is |
| | for position with AI/ML model operations. |
| | The same logic for “beam management”, “CSI compression” etc. |
| ID | ID is used to distinguish the AI functionalities, for example, |
| | 1: the configuration is for position with AI/ML model operations. |
| | 2: the configuration is for beam management with AI/ML model |
| | operations. |
| | The same logic for other AI/ML based functionalities |
| Bitmap | Bitmap is used to distinguish the AI functionalities, each bit represents |
| | a specific AI function, 0 means invalid but reverse when it's 1, for |
| | example, |
| | “1000”: the last bit is “1”, which means the configuration is used for |
| | position with AI/ML model operations. |
| | The same logic for other AI/ML based functionalities. |

In table 6, resource type indication method may include string, ID, and bitmap indications, etc. In string, “positioning AI/ML model based” means the configuration is for position with AI/MVL, model operations. ID 1 means that the configuration is for position with AI/ML model operations. ID 2 means that the configuration is for beam management with AI/ML model operations, and so on. The same logic is used for “beam management”, “CSI compression” etc. Bitmap is used to distinguish the AI functionalities, each bit represents a specific AI function, 0 means invalid but reverse when it's 1. In bitmap, for example, “1000”: the last bit is “1”, which means the configuration is used for position with AI/ML model operations.

### Embodiment 5: Uplink AI/ML Model Specific CSI/Reporting/Feedback to UE

In some examples, the base station configures to the UE, a reporting, wherein the reporting is configured to indicate a measurement information between a network device (i.e., the base station) and the UE based on the AI/ML model specific reference signal. In some examples, the base station configures to the UE, an AI/ML model specific channel state information. In some examples, the AI/ML model specific channel state information comprises: at least one of the following: an identifier of the AI/ML model; an identifier of the AI/ML type; an identifier of the AI/ML functionality; an identifier of the AI/ML scenario; an identifier of the AI/ML model procedure; and/or an identifier of the reference signal.

Due to the uplink data transmission is controlled by the network device, the UE does not need anything about the uplink transmission channel state information. But for UE located AI/ML model operation (e.g., one-side, two side), as discussed in the above, network-side measurement information from the uplink reference signal is mandatory. To address those mentioned problems, the following framework is proposed.

1) One new report configuration from the network device to the UE would be defined.

2) The report configuration includes at least AI/ML model specific uplink reference signal configuration, feedback information from the network device to the UE, and feedback behavior (timing, frequency etc.). The feedback information is from the network device to the UE, it's AI/ML model specific, where the AI/ML model specific information can be indicated as AI/ML model ID, AI mode type, AI/ML model functionality etc.

### Embodiment 6: AI/ML Model Specific Information Feedback from NW to UE

FIG. 11 is a schematic diagram illustrating AI/ML model specific uplink feedback according to an embodiment of the present disclosure. FIG. 11 illustrates that, in some embodiments, in Step 1: the UE receives an AI/ML model specific configuration from the network device, in Step 2: The network device receives an AI/ML model specific reference signal from the UE, in Step 3: The network device performs a measurement based on the AI/ML model specific reference signal, and in Step 4: The network device transmits an AI/ML model specific information feedback to the UE.

As illustrated in FIG. 11, for the AI/ML model specific information feedback from the network device to the UE side, the following information would be included.

1) AI/ML model related description information.

2) AI/ML model specific data obtained from uplink reference signal's measurement or calculation.

For the AI/ML model related description information, it can be indicated as the following information.

1) AI/ML model ID, AI mode type, AI/ML model functionality etc. They directly reveal the feedback content from network, and then the UE can perform AI operation based on the decoded information.

2) AI/ML model specific SRS resource index. The SRS resource index is also effective because the AI/ML model information is part of SRS resource configuration.

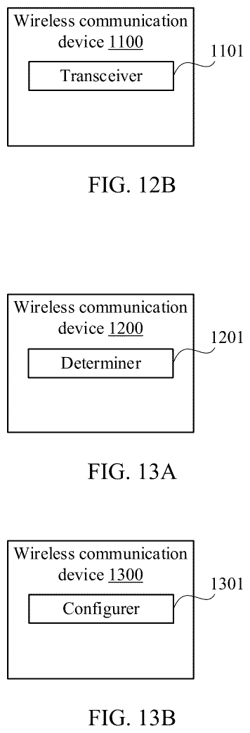

FIG. 12A is a block diagram of a communication device 1000 such as UE according to an embodiment of the present disclosure. The communication device 1000 may be a first node such as a UE. The communication device 1000 includes a transceiver 1001 configured to receive, from a network device, a downlink AI/ML model specific reference signal configuration, wherein the downlink AI/ML model specific reference signal configuration comprises a resource type indication used to indicate at least one of the following: an identifier of the AI/ML model; an identifier of the AI/ML type; an identifier of the AI/ML functionality; an identifier of the AI/ML model procedure; an identifier of the AI/ML scenario; and/or an identifier of the reference signal. The transceiver 1001 is further configured to transmit, to the network device, a downlink AI/ML model specific channel state information (CSI)/reporting/feedback. This can solve the issues in the prior art, reduce a signaling overhead, provide scalability to different models' requirement for one AI/ML model type, and unify one-side model or two-side model's procedure with a single AI/ML model specific process.

In some examples, the resource type indication comprises at least one of the following: a string-based indication, an ID-based indication, a bitmap-based indication, a reference signal name-based indication, and/or a configuration order. In some examples, the resource type indication is structured with a hierarchical methodology to fulfill different scenarios for a plurality of AI/ML models for one specific AI/ML function. In some examples, the one or more reference signal types comprises at least one of the following: a configuration used for a CSI measurement without an AI/ML mode, and/or a configuration used for one or more AI/ML model based operations comprising an AI/ML model training/monitoring and/or CSI feedback. In some examples, the one or more AI/ML functionalities comprises at least one of the following: a positioning with one or more AI/ML model operations, a beam management with one or more AI/ML model operations, and/or a CSI compression with one or more AI/ML model operations.

In some examples, the configuration order comprises at least one of the following: a first resource configuration used for a non-AI based channel measurement, a second resource configuration used for an interference measurement (IM) with a CSI-IM resource, a third resource configuration used for a non-zero power channel state information reference signal (NZP-CSI-RS) based interference measurement, a fourth resource configuration used for an AI/ML model based CSI operation, and/or a fifth resource configuration used for an AI/ML model based beam management operation. In some examples, for the downlink AI/ML model specific CSI/reporting/feedback comprises a dedicated indication used to the one or more AI/ML functionalities. In some examples, the dedicated indication comprises at least one of the following: a dedicated reporting quantity used for one or more AI/ML model based operations, a dedicated reporting configuration comprising an AI/ML model specific information, and/or a dedicated measurement configuration comprising the AI/ML model specific information.

In some examples, the AI/ML model specific information comprises at least one of the following: an AI/ML model ID, an AI/ML mode type, an AI/ML model functionality, and/or a reference signal index. In some examples, the one or more AI/ML model based operations comprise a downlink AI/ML model specific operation triggered by an aperiodic on-demand operation or a semi-static on-demand operation. In some examples, the downlink AI/ML model specific operation is triggered by an active/de-active information for a specific AI/ML model, which is carried by a media access control-control element (MAC-CE) signaling or a physical downlink control channel (PDCCH) signaling. In some examples, the downlink AI/ML model specific operation is triggered by an AI/ML model specific active/de-active timing, and the AI/ML model specific active/de-active timing is predefined or carried by a MAC-CE signaling or a radio resource control (RRC) signaling.

In another embodiments, the transceiver 1001 is configured to receive, from a network device, an uplink AI/ML model specific reference signal configuration, wherein the uplink AI/ML model specific reference signal configuration comprises a resource type indication used to indicate at least one of the following: an identifier of the AI/ML model; an identifier of the AI/ML type; an identifier of the AI/ML functionality; an identifier of the AI/ML model procedure; an identifier of the AI/ML scenario; and/or an identifier of the reference signal. The transceiver 1001 is further configured to receive, from the network device, an uplink AI/ML model specific channel state information (CSI)/reporting/feedback. The transceiver 1001 is further configured to receive, from the network device, a feedback of an AI/ML model specific information. This can solve the issues in the prior art, reduce a signaling overhead, provide scalability to different models' requirement for one AI/ML model type, and unify one-side model or two-side model's procedure with a single AI/ML model specific process.

In some examples, the resource type indication comprises at least one of the following: a string-based indication, an ID-based indication, a bitmap-based indication, a reference signal name-based indication, and/or a configuration order. In some examples, the resource type indication is structured with a hierarchical methodology to fulfill different scenarios for a plurality of AI/ML models for one specific AI/ML function. In some examples, the one or more reference signal types comprises at least one of following: a configuration used for a CSI measurement without an AI/ML mode, and/or a configuration used for one or more AI/ML model based operations comprising an AI/ML model training/monitoring and/or CSI feedback. In some examples, the one or more AI/ML functionalities comprises a positioning with one or more AI/ML model operations, a beam management with one or more AI/ML model operations, and/or a CSI compression with one or more AI/ML model operations.

In some examples, the configuration order comprises a first resource configuration used for a non-AI based channel measurement, a second resource configuration used for an interference measurement (IM) with a CSI-IM resource, a third resource configuration used for a non-zero power channel state information reference signal (NZP-CSI-RS) based interference measurement, a fourth resource configuration used for an AI/ML model based CSI operation, and/or a fifth resource configuration used for an AI/ML model based beam management operation. In some examples, for the uplink AI/ML model specific CSI/reporting/feedback comprises an AI/ML model specific uplink reference signal configuration, a feedback information from the network device to the UE, and/or a feedback behavior. In some examples, the AI/ML model specific information comprises an AI/ML model related description information and/or an AI/ML model specific data from an uplink reference signal measurement or calculation. In some examples, the AI/ML model related description information comprises an AI/ML model ID, an AI/ML mode type, an AI/ML model functionality, a reference signal index, and/or an AI/ML model specific sounding reference signal (SRS) resource index.

FIG. 12B is a block diagram of a communication device 1100 such as a network device according to an embodiment of the present disclosure. The communication device 1100 may be a second node such as a network device. The communication device 1100 includes a transceiver 1101 configured to transmit, to a user equipment (UE), a downlink AI/ML model specific reference signal configuration, wherein the downlink AI/ML model specific reference signal configuration comprises a resource type indication used to indicate one or more reference signal types, one or more AI/ML functionalities, and/or reference signal usage. The transceiver 1001 is further configured to receive, from the UE, a downlink AI/ML model specific channel state information (CSI)/reporting/feedback. This can solve the issues in the prior art, reduce a signaling overhead, provide scalability to different models' requirement for one AI/ML model type, and unify one-side model or two-side model's procedure with a single AI/ML model specific process.

In another embodiments, the transceiver 1101 is configured to transmit, to a user equipment (UE), an uplink AI/ML model specific reference signal configuration, wherein the uplink AI/ML model specific reference signal configuration comprises a resource type indication used to indicate one or more reference signal types, one or more AI/ML functionalities, and/or reference signal usage. The transceiver 1101 is further configured to transmit, to the UE, an uplink AI/ML model specific channel state information (CSI)/reporting/feedback. The transceiver 1101 is further configured to feedback, to the UE, an AI/ML model specific information. This can solve the issues in the prior art, reduce a signaling overhead, provide scalability to different models' requirement for one AI/ML model type, and unify one-side model or two-side model's procedure with a single AI/ML model specific process.

FIG. 13A is a block diagram of a communication device 1200 such as UE according to an embodiment of the present disclosure. The communication device 1200 may be a first node such as a UE. The communication device 1200 includes a determiner 1201 configured to determine an AI/ML model specific reference signal configuration, wherein the AI/ML model specific reference signal configuration comprises an indication to indicate a reference signal usage of an AI/ML model specific reference signal, and the reference signal usage comprises at least one of the following: AI/ML functionality, AI/ML model, AI/ML model procedure, and/or AI/ML scenario. This can solve the issues in the prior art, reduce a signaling overhead, provide scalability to different models' requirement for one AI/ML model type, and unify one-side model or two-side model's procedure with a single AI/ML model specific process.

In some examples, the indication to indicate the reference signal usage includes: an identifier of the AI/ML model; an identifier of the AI/ML type; an identifier of the AI/ML functionality; an identifier of the AI/ML scenario; an identifier of the AI/ML model procedure; an identifier of the reference signal; a string-based indication; an ID-based indication; a bitmap-based indication; a hierarchical methodology-based indication; and/or an order-based indication. In some examples, through the order-based indication, AI/ML related reference signals of the AI/ML model specific reference signal configuration are indicated with different configured orders. In some examples, the AI/ML model specific reference signal comprises a channel state information-reference signal (CSI-RS), a demodulation reference signal (DMRS), a sounding reference signal (SRS), a phase tracking reference signal (PTRS), and/or a positioning reference signal (PRS). In some examples, the method further includes receiving, from the UE, an AI/ML model specific reporting information configuration, wherein the AI/ML model specific reporting information configuration comprises an indication to indicate an AI/ML model information. In some examples, the indication to indicate the AI/ML model information comprises: an identifier of the AI/ML model; an identifier of the AI/ML type; an identifier of the AI/ML functionality; an identifier of the AI/ML scenario; an identifier of the AI/ML model procedure; and/or an identifier of the reference signal. In some examples, the AI/ML model specific reference signal configuration and/or the AI/ML model specific reporting information configuration are active/de-active by a triggering information.

In some examples, the triggering information comprises: an identifier of the AI/ML model; an identifier of the AI/ML type; an identifier of the AI/ML functionality; an identifier of the AI/ML scenario; an identifier of the AI/ML model procedure; an identifier of the reference signal; an identifier of a reporting quantity; active timing; and/or de-active timing. In some examples, the method further includes configurating, to the UE, a reporting, wherein the reporting is configured to indicate a measurement information between a network device and the UE based on the AI/ML model specific reference signal. In some examples, the method further includes configurating, to the UE, an AI/ML model specific channel state information. In some examples, the AI/ML model specific channel state information feedback comprises an identifier of the AI/ML model; an identifier of the AI/ML type; an identifier of the AI/ML functionality; an identifier of the AI/ML scenario; an identifier of the AI/ML model procedure; and/or an identifier of the reference signal.

FIG. 13B is a block diagram of a communication device 1300 such as a network device according to an embodiment of the present disclosure. The communication device 1300 may be a second node such as a network device. The communication device 1300 includes a configurer 1301 configured to configure, to a user equipment (UE), an AI/ML model specific reference signal configuration, wherein the AI/ML model specific reference signal configuration comprises an indication to indicate a reference signal usage of an AI/ML model specific reference signal, and the reference signal usage comprises at least one of the following: AI/ML functionality, AI/ML model, AI/ML model procedure, and/or AI/ML scenario. This can solve the issues in the prior art, reduce a signaling overhead, provide scalability to different models' requirement for one AI/ML model type, and unify one-side model or two-side model's procedure with a single AI/ML model specific process.

In some examples, the indication to indicate the reference signal usage comprises: an identifier of the AI/ML model; an identifier of the AI/ML type; an identifier of the AI/ML functionality; an identifier of the AI/ML scenario; an identifier of the AI/ML model procedure; an identifier of the reference signal; a string-based indication; an ID-based indication; a bitmap-based indication; a hierarchical methodology-based indication; and/or an order-based indication. In some examples, through the order-based indication, AI/ML related reference signals of the AI/ML model specific reference signal configuration are indicated with different configured orders. In some examples, the AI/ML model specific reference signal comprises a channel state information-reference signal (CSI-RS), a demodulation reference signal (DMRS), a sounding reference signal (SRS), a phase tracking reference signal (PTRS), and/or a positioning reference signal (PRS). In some examples, the method further includes transmitting, to a network device, an AI/ML model specific reporting information configuration, wherein the AI/ML model specific reporting information configuration comprises an indication to indicate an AI/ML model information. In some examples, the indication to indicate the AI/ML model information comprises an identifier of the AI/ML model; an identifier of the AI/ML type; an identifier of the AI/ML functionality; an identifier of the AI/ML scenario; an identifier of the AI/ML model procedure; and/or an identifier of the reference signal.

In some examples, the AI/ML model specific reference signal configuration and/or the AI/ML model specific reporting information configuration are active/de-active by a triggering information. In some examples, the triggering information comprises: an identifier of the AI/ML model; an identifier of the AI/ML type; an identifier of the AI/ML functionality; an identifier of the AI/ML scenario; an identifier of the AI/ML model procedure; an identifier of the reference signal; an identifier of a reporting quantity; active timing; and/or de-active timing. In some examples, the method further includes determining, by the UE, a reporting, wherein the reporting is configured to indicate information between a network device and the UE based on the AI/ML model specific reference signa. In some examples, the method further includes determining, by the UE, an AI/ML model specific channel state information feedback. In some examples, the AI/ML model specific channel state information comprises: an identifier of the AI/ML model; an identifier of the AI/ML type; an identifier of the AI/ML functionality; an identifier of the AI/ML scenario; an identifier of the AI/ML model procedure; and/or an identifier of the reference signal.

In the above embodiments of this disclosure, the term “/” can be interpreted to indicate “and/or.”

In summary, in some embodiments of this disclosure, downlink AI/ML model specific reference signal configuration, downlink AI/ML model specific CSI/reporting/feedback to network, on-demand downlink AI/ML model specific operation triggering, uplink AI/ML model specific reference signal configuration, uplink AI/ML model specific CSI/reporting/feedback to UE, and/or AI/ML model specific information feedback from NW to UE are disclosed to solve the issues in the prior art, reduce a signaling overhead, provide scalability to different models' requirement for one AI/ML model type, and unify one-side model or two-side model's procedure with a single AI/ML model specific process.

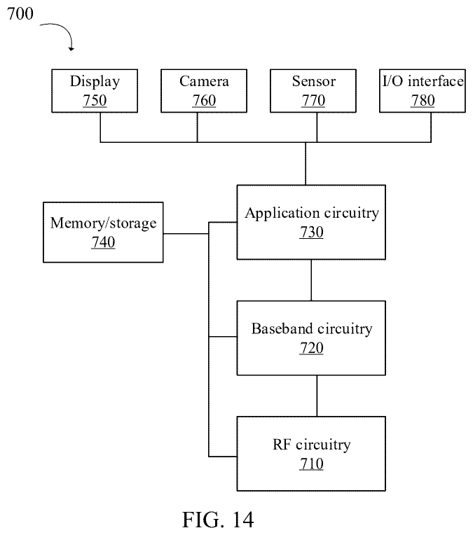

FIG. 14 is a block diagram of an example system 700 for wireless communication according to an embodiment of the present disclosure. Embodiments described herein may be implemented into the system using any suitably configured hardware and/or software. FIG. 14 illustrates the system 700 including a radio frequency (RF) circuitry 710, a baseband circuitry 720, an application circuitry 730, a memory/storage 740, a display 750, a camera 760, a sensor 770, and an input/output (I/O) interface 780, coupled with each other at least as illustrated. The application circuitry 730 may include a circuitry such as, but not limited to, one or more single-core or multi-core processors. The processors may include any combination of general-purpose processors and dedicated processors, such as graphics processors, application processors. The processors may be coupled with the memory/storage and configured to execute instructions stored in the memory/storage to enable various applications and/or operating systems running on the system.

The monitoring of a ML model is not limited to a UE or a gNB. The monitoring can be performed in third node The related signaling and data need to be reported to the third node. The third node can be a UE, a gNB or a server. The methods in the embodiments apply. In this way, the signaling overhead is reduced between the gNB and the UE

While the present disclosure has been described in connection with what is considered the most practical and preferred embodiments, it is understood that the present disclosure is not limited to the disclosed embodiments but is intended to cover various arrangements made without departing from the scope of the broadest interpretation of the appended claims.

1. A wireless communication method of artificial intelligence (AI)/machine learning (ML), comprising:
configurating, to a user equipment (UE), an AI/ML specific reference signal configuration, wherein the AI/ML specific reference signal configuration comprises an indication to indicate a reference signal usage of an AI/ML specific reference signal, and the reference signal usage comprises at least one of the following: AI/ML functionality, AI/ML model, AI/ML model procedure, and/or AI/ML scenario.

2. The method according to claim 1, wherein the indication to indicate the reference signal usage comprises at least one of the following:
an identifier of the AI/ML model;
an identifier of the AI/ML type;
an identifier of the AI/ML functionality;
an identifier of the AI/ML scenario;
an identifier of the AI/ML model procedure;
an identifier of the reference signal;
a string-based indication;
an ID-based indication;
a bitmap-based indication;
a hierarchical methodology-based indication; and/or
an order-based indication.

3. The method according to claim 2, wherein through the order-based indication, the AI/ML specific reference signal usage is indicated with different configured orders.

4. The method according to claim 1, wherein the AI/ML specific reference signal comprises at least one of the channel state information reference signal (CSI-RS), demodulation reference signal (DMRS), sounding reference signal (SRS), phase tracking reference signal (PTRS), and/or positioning reference signal (PRS).

5. The method according to claim 1, further comprising:
receiving, from the UE, an AI/ML model specific reporting information configuration, wherein the AI/ML model specific reporting information configuration comprises an indication to indicate an AI/ML model information.

6. The method according to claim 5, wherein the indication to indicate the AI/ML model information comprises at least one of the following:
an identifier of the AI/ML model;
an identifier of the AI/ML type;
an identifier of the AI/ML functionality;
an identifier of the AI/ML model procedure;
an identifier of the AI/ML scenario; and/or
an identifier of the reference signal.

7. The method according to claim 5, wherein the AI/ML specific reference signal configuration and/or the AI/ML model specific reporting information configuration is active/de-active by a triggering information.

8. The method according to claim 7, wherein the triggering information comprises at least one of the following:
an identifier of the AI/ML model;
an identifier of the AI/ML type;
an identifier of the AI/ML functionality;
an identifier of the AI/ML scenario;
an identifier of the AI/ML model procedure;
an identifier of the reference signal;
an identifier of a reporting quantity;
active timing; and/or
de-active timing.

9. The method according to claim 1, further comprising:
configurating, to the UE, a reporting, wherein the reporting is configured to indicate a measurement information between a network device and the UE based on the AI/ML specific reference signal.

10-11. (canceled)

12. A wireless communication method of artificial intelligence (AI)/machine learning (ML), comprising:
determining, by a user equipment (UE), an AI/ML specific reference signal configuration, wherein the AI/ML specific reference signal configuration comprises an indication to indicate a reference signal usage of an AI/ML specific reference signal, and the reference signal usage comprises at least one of the following: AI/ML functionality, AI/ML model, AI/ML model procedure, and/or AI/ML scenario.

13-22. (canceled)

23. A network device, comprising:
a memory;
a transceiver; and
a processor coupled to the memory and the transceiver;
wherein the processor is configured to:
configure, to a user equipment (UE), an AI/ML specific reference signal configuration, wherein the AI/ML specific reference signal configuration comprises an indication to indicate a reference signal usage of an AI/ML specific reference signal, and the reference signal usage comprises at least one of the following: AI/ML functionality, AI/ML model, AI/ML model procedure, and/or AI/ML scenario.

24-26. (canceled)

27. The method according to claim 1, wherein the AI/ML specific reference signal configuration comprises a positioning-AI resource for measurement or a beam management-AI resource for measurement.

28. The method according to claim 1, wherein the indication of the AI/ML specific reference signal configuration indicates a reporting type comprises at least one of none, a positioning, a beam management, or a channel state information (CSI).

29. The method according to claim 28, wherein when the reporting type is none, the indication of the AI/ML specific reference signal configuration indicates that no beam management report or CSI report is required.

30. The method according to claim 12, wherein the AI/ML specific reference signal configuration comprises a positioning-AI resource for measurement or a beam management-AI resource for measurement.

31. The method according to claim 12, wherein the indication of the AI/ML specific reference signal configuration indicates a reporting type comprises at least one of none, a positioning, a beam management, or a channel state information (CSI).

32. The method according to claim 31, wherein when the reporting type is none, the indication of the AI/ML specific reference signal configuration indicates that no beam management report or CSI report is required.

33. The network device according to claim 23, wherein the AI/ML specific reference signal configuration comprises a positioning-AI resource for measurement or a beam management-AI resource for measurement.

34. The network device according to claim 23, wherein the indication of the AI/ML specific reference signal configuration indicates a reporting type comprises at least one of none, a positioning, a beam management, or a channel state information (CSI).

35. The network device according to claim 34, wherein when the reporting type is none, the indication of the AI/ML specific reference signal configuration indicates that no beam management report or CSI report is required.
